(19) United States
(12) Patent Application Publication
(10) Pub. No.: US 2022/0266690 A1
(43) Pub. Date: Aug. 25, 2022

(54) POWERTRAIN SITUATIONAL CALIBRATION

(71) Applicant: Ford Global Technologies, LLC, Dearborn, MI (US)

(72) Inventors: Walter Joseph Ortmann, Saline, MI (US); Ashish Kumar Naidu, Canton, MI (US); Mark Anthony Tascillo, Canton, MI (US); Naginder Gogna, Northville, MI (US)

(21) Appl. No.: 17/180,175

(22) Filed: Feb. 19, 2021

(51) Int. Cl. B60K 26/02; B60L 50/60; B60L 15/20

(52) U.S. Cl. CPC B60K 26/021; B60L 50/60; B60L 15/20; B60K 2026/026; B60L 2240/423; B60L 2240/66; B60L 2250/26; B60L 2240/68; B60L 2240/645

(57) ABSTRACT

A powertrain system includes a powertrain and a controller. The controller commands a change in torque produced by the powertrain for a given change in pedal position according to a default calibration schedule that is defined by a driving style of a driver such that the change in torque is different for different drivers.

### TECHNICAL FIELD

This disclosure relates to the operation of automotive powertrains.

### BACKGROUND

Current vehicle powertrain calibrations may provide consistent responses to a driver's input from the accelerator and brake pedals independent of the vehicle's location, environment, or driver behavior.

### SUMMARY

A powertrain system includes a powertrain and a controller. The controller commands a change in torque produced by the powertrain for a given change in pedal position according to a default calibration schedule that is defined by a driver such that the change in the torque is different for different drivers, and for as long as a predefined set of driving conditions is present, commands the change in the torque according to an override calibration schedule and not the default calibration schedule provided that the change in the torque according to the override calibration schedule is different than the change in the torque according to the default calibration schedule, and commands the change in the torque according to the default calibration schedule otherwise.

A vehicle includes a drivetrain, a traction battery that provides electrical energy to the drivetrain, and a controller. The controller operates the traction battery and drivetrain to propel the vehicle according to a first responsiveness of the drivetrain to pedal inputs based on identification of a first driver and a first set of environmental conditions, and operates the traction battery and drivetrain to propel the vehicle according to a second responsiveness of the drivetrain to pedal inputs based on identification of the first driver and a second set of environmental conditions.

A method includes, while a vehicle is not on a highway, commanding a change in torque produced by a powertrain of the vehicle for a given change in pedal position according to a default calibration schedule that is defined by a driving style of the driver such that the change in torque is different for different drivers, and while the vehicle is on a highway, commanding the change in the torque according to an override calibration schedule and not the default calibration schedule provided that the change in the torque according to the override calibration schedule is different than the change in the torque according to the default calibration schedule.

### BRIEF DESCRIPTION OF THE DRAWINGS

FIG. 1 illustrates a vehicle.

FIG. 2 illustrates a first calibration algorithm.

FIG. 3 illustrates a second calibration algorithm.

FIG. 4 illustrates an optimal driving behavior algorithm.

### DETAILED DESCRIPTION

The disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A battery electric vehicle powertrain may provide a greater ability to customize how the powertrain will respond to pedal input. Under various driving conditions, the desired pedal response can change based on the location, driving style, environment, or situation. Currently, certain calibration processes may not consider the actual situation that the driver/vehicle are currently experiencing. Each driver has a unique behavior and way of reacting to a given situation. One solution may take into consideration the location (e.g., city, highway, parking lot, driveway, subdivision, etc.), the environment (e.g., icy, wet), and/or the driver's style of driving to provide a more compatible powertrain response verses a single response to every situation.

One such embodiment may comprise a vehicle. The vehicle may optionally include an engine. The engine may be used to provide torque to a propulsion system within the vehicle. The engine may convert chemical energy from a fuel source into mechanical energy. In particular, the engine may provide mechanical energy in the form of rotational energy exerted upon a crankshaft. The engine may be configured to provide the mechanical energy to a transmission through the crankshaft. The engine may be in communication with a vehicle controller. The engine may include a plurality of sensors. One of the sensors may determine and provide engine parameters to a vehicle controller. For example, an engine sensor may determine and provide engine speed, fuel economy, lubricant level, or other engine parameters.

The vehicle may comprise a vehicle battery. The vehicle battery maybe used to provide torque to a propulsion system within the vehicle. The vehicle battery may be a traction battery. The vehicle battery may be used to store electrical energy. Further, the vehicle battery may supply power to a motor to convert stored electrical energy into mechanical energy to propel the vehicle. The vehicle battery may include a plurality of battery cells. In some embodiments, at least two of the battery cells of the plurality of battery cells are in series. In such embodiments, the electrical potential of both of the battery cells may be summed. Alternatively, or additionally, at least two of the battery cells of the plurality of battery cells are in parallel. In such embodiments, the electrical current capacity may be summed. The vehicle battery may have a plurality of sensors. One of the sensors may determine and provide battery parameters to a vehicle controller.

The vehicle battery may have a plurality of terminals. In some embodiments, the vehicle battery may have a pair of terminals. In such embodiments, one of the pair of terminals may be a positive terminal. The positive terminal may be a terminal in direct electrical connection with a positive lead of a vehicle battery. The positive terminal may be in direct electrical communication with a leading vehicle load. The positive terminal may be in electrical communication with a common ground bus terminal via the leading vehicle load. The vehicle battery may have a negative terminal. Similar to the positive terminal, the negative terminal may be in direct electrical communication with a lagging vehicle load. Also, the negative terminal may be in electrical communication with a common ground via the lagging vehicle load.

A vehicle battery having a plurality of battery cells may have a plurality of positive terminals and a plurality of negative terminals. Each of the cells of the plurality of battery cells may comprise a pair of terminals. Further, the vehicle battery may have a plurality of positive terminals, wherein one of the positive terminals of the plurality of terminals is in electrical communication with another of the positive terminals of the plurality of terminals via a positive terminal bus. Similarly, the vehicle battery may have a plurality of negative terminals, wherein one of the negative terminals of the plurality of terminals is in electrical communication with another of the negative terminals of the plurality of terminals via a negative terminal bus.

Further, a vehicle battery having a plurality of battery cells may have a plurality of cell relays. A vehicle including a vehicle battery having a plurality of battery cells in parallel may further include a cell relay between each of the battery cells and one of the positive terminal bus and the negative terminal bus. A vehicle including a vehicle battery having a plurality of battery cells in series may further include a cell relay between each of the battery cells of the plurality of battery cells, wherein when one of the cell relays is in a first position, a battery cell is series attached to another battery cell, and wherein when the one of the cell relays is in a second position, the battery cell is electrically disconnected from the another battery cell. In some embodiments, the remaining plurality of battery cells will continue to function.

The vehicle may comprise a drivetrain. The drivetrain may be in at least one of electrical, magnetic, and mechanical communication with at least one of an internal combustion engine, an electric power source, and/or a regenerative braking system. In some embodiments, the drivetrain may be in fluid communication with the internal combustion engine if present. For example, the vehicle may have a torque converter between the drivetrain and the internal combustion engine. Alternatively, the vehicle may have a clutch between the drivetrain and the internal combustion engine.

The vehicle may comprise a generator. The generator may be configured to convert mechanical energy into electrical energy. In some embodiments, the generator may be configured to convert mechanical energy from an internal combustion engine if present into electrical energy for charging a vehicle battery. The generator may also be used to convert mechanical energy from an internal combustion engine into electrical energy for powering a vehicle load. The generator may be configured to output DC electricity.

The vehicle may comprise a motor. The motor may be configured to convert electrical energy into mechanical energy. For example, the motor may be configured to receive electrical energy from a vehicle battery to provide mechanical energy to a vehicle drivetrain. Alternatively, the motor may be configured to receive electrical energy from an electrical bus network. As such, the motor may be configured to receive electrical energy from other vehicle components configured to provide electrical energy to the electrical bus network. The motor may be configured to receive DC electricity.

The vehicle may comprise a regenerative braking system. The regenerative braking system may be in mechanical communication with a plurality of vehicle wheels. The regenerative braking system may be used to convert mechanical energy into electrical energy. For example, the regenerative braking system may be used to convert inertia from braking into electrical energy by using in part, a magnet, to reduce the absolute velocity of the vehicle. Changing magnetic flux may produce an electrical current. The regenerative braking system may be configured to provide the electrical current to an electrical component of the vehicle. For example, the regenerative braking system may be in electrical communication with a vehicle battery, such that the regenerative braking system is configured to produce electricity from inertia gathered from the mechanical communication with the vehicle wheels. Electricity gathered from the regenerative braking system may be converted by the converter such that its electrical parameters are suited for either of the high-voltage and low-voltage electrical bus networks. Alternatively, the regenerative braking system may be configured to produce electricity having electrical parameters suited for either of the high-voltage and low-voltage electrical bus networks.

The vehicle may comprise a power network. The power network may be configured to facilitate the electrical communication between power electronics within the vehicle. The power network may use a plurality of electrical bus networks to facilitate the communication. One of the electrical bus networks may be a high-voltage bus network. The high-voltage bus network may be configured to provide DC electricity to electrical components requiring a high voltage. For example, the high-voltage bus network may be configured to have an electrical potential difference of 500 volts. The high-voltage bus network may be configured to be in direct electrical communication with a vehicle battery. Another of the electrical bus networks may be a low-voltage bus network. The low-voltage bus network may be configured to provide DC electricity to electrical components that require a low voltage. For example, the low-voltage bus network may be configured to have an electrical potential difference of 12 volts. The low-voltage bus network may be in direct electrical communication with a supplementary battery. The power network may have a converter. The converter may be configured to convert electricity of a first set of electrical parameters into a second set of electrical parameters. For example, the converter may be configured to convert electricity at 500 volts into electricity at 12 volts. The power network may include a common ground. The ground may be configured to act as a source of low electrical potential to facilitate the flow of electrical current. In some embodiments, the high-voltage bus network shares a common ground with the low-voltage bus network. Alternatively, the power network may have a plurality of electrical grounds.

The power network may comprise a converter. The converter may be configured to alter electricity of a first set of parameters into electricity of a second set of parameters. In one embodiment, the converter may convert high voltage electricity into low voltage electricity. For example, the converter may convert 480 volts into 24 volts. Additionally, or alternatively, the converter may converter electricity having 24 volts into electricity having 480 volts. The converter may be bidirectional regarding direction of conversion. In some embodiments, the converter may be configured to vary its conversion. In such examples, the converter may be configured to change its conversion in response to a command from a controller. For example, the converter may be configured to convert 480 volts into 24 volts in response to a first command from a controller, and further configured to convert 480 volts into 12 volts in response to a second command from the controller.

The vehicle may comprise a driver identification system. The driver identification system may be used to determine when a first user is the driver and when a second user is a driver. The driver identification system may monitor the key used to start the vehicle. Additionally, or alternatively, the driver identification system may monitor a mobile device indicative of a user. Even further, the driver identification system may use biometric data of a user to identify a user.

The vehicle may comprise an environmental setting system. The vehicle may include sensors to determine environmental settings. For example, the vehicle may include a sensor to determine a wet climate in contrast to a drier climate. Further, the vehicle may include a controller configured to receive wireless updates from a remote location indicative of environmental settings, such as weather, road conditions, road grade, road speed regulations, and other environmental settings.

The vehicle may comprise one or more controllers. The controller may include a memory system and a processor. The memory system may be configured to store instruction sets such as programs, algorithms, methods, etc. The memory system may be further configured to receive, monitor, and store values presented to the controller. Further, the memory may serve as a database. As such, the memory may create, store, and edit data stored in the database. The database may define a repository. Alternatively, or additionally, the database may define a plurality of repositories. A repository may be used to store historical values experienced by the vehicle. The database may define a schedule. Alternatively, or additionally, the database may define a plurality of schedules. A schedule may include entries used as reference for operating a device. The processor may be configured to execute instruction sets. The controller may be configured to receive signals indicative of information from external sources including but not limited to sensors, devices, and other controllers. The controller may be configured to receive information by various ways including electrical communication and electro-magnetic communication.

The controller may be a vehicle controller. As such, the controller may be in communication with an engine if present, a vehicle battery, a drivetrain, an exhaust system, a generator, and a motor of the vehicle. The controller may further be in commutation with braking systems, including a regenerative braking system and a friction braking system. The controller may be configured to retrieve values from each of the components of the vehicle such as engine speed, battery SOC, vehicle torque, exhaust flow, and the conditions of a vehicle power network.

In one embodiment having a vehicle controller, the vehicle controller has a user repository. The user repository may be used to store battery usage behavior by a user of the vehicle. In addition, the repository may be used to store battery usage behavior by multiple users of the vehicle. Alternatively, or additionally, the repository may be used to store vehicle acceleration behavior by one or multiple users of the vehicle. The vehicle controller may further include a calibration schedule. The calibration schedule may be used to alter battery performance experienced by the vehicle in response to a request from a user. The calibration schedule may include a default calibration setting. The default calibration setting may be configured to allow standard battery power in response to requests for torque from a user. The calibration schedule may have an aggressive calibration setting. The aggressive calibration setting may be configured to request increased battery power in response to a request for torque from a user. The calibration schedule may include a passive calibration setting. The passive calibration setting may be configured to request decreased battery power in response to a request for torque from a user.

The calibration schedule may define a battery protocol. A battery protocol may be a battery bias pattern in which the battery releases energy according to the protocol at different vehicle parameters. For example, an aggressive battery protocol may release more energy for a torque request at a higher speed than at a lower speed. A battery protocol may include a battery bias pattern in which the protocol is configured to request increased battery power at a first vehicle parameter, and a decreased battery power at a second vehicle parameter. For example, the battery protocol may be configured to request an increased battery power at 25 mph, and configured to request a decreased battery power at 70 mph.

The controller may be configured to receive a signal indicative of an environmental setting. For example, the controller may be configured to receive a signal indicating at least one of road traffic, weather, road grade, path distance, and other conditions. Additionally, or alternatively, the controller may be configured to receive a plurality of signals indicative of a plurality of environmental settings. Even further, the controller may be configured to receive a signal indicative of a future environmental setting. For example, the controller may be configured to receive a signal indicating at least one of impending road traffic, impending weather, and other impending conditions.

The controller may compare the expected driving behavior of the user to an optimal driving behavior. If the expected driving behavior does not match the optimal driving behavior, the controller may apply a calibration to the battery to increase the chance of reaching an optimal driving behavior. For example, if the optimal driving behavior is for increased acceleration and deceleration in congested traffic, while the controller expects the driver to drive passively, the controller may apply an aggressive calibration setting to the battery. The controller may be configured to determine a battery protocol to optimize the vehicle battery based in part on the complete driving path.

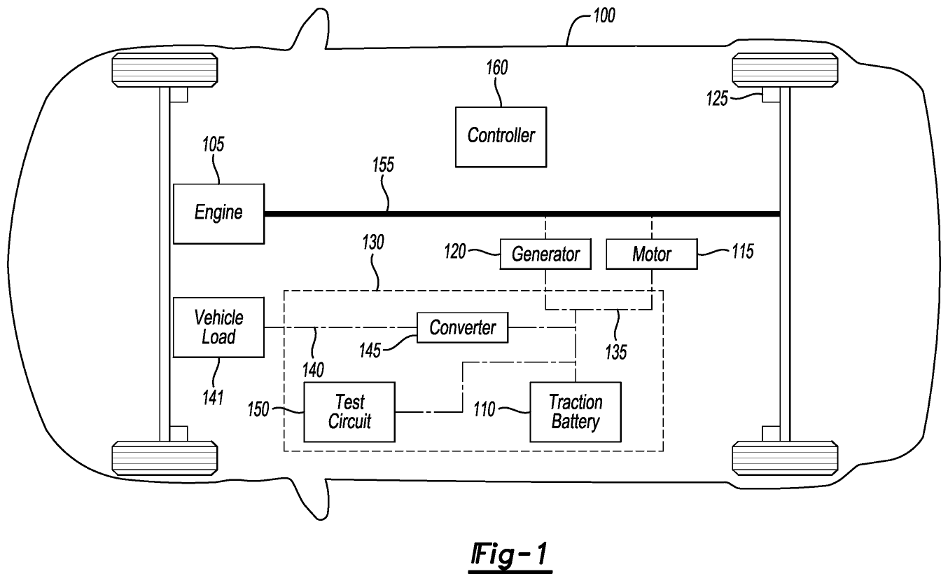

FIG. 1 illustrates a vehicle 100. The vehicle 100 includes an engine 105, a traction battery 110, a motor 115, a generator 120, a drivetrain 155, a regenerative braking system 125, and a power network 130. The engine 105 is in mechanical communication with the drivetrain 155 and acts to provide torque to the drivetrain 155. The vehicle 100 also includes a controller 160. The controller 160 is configured to selectively operate many of the components of the vehicle 100. Further, the controller 160 is configured to receive signals from various sensors throughout the vehicle 100 indicative of vehicle metrics, performance, status, among other things. The engine 105 is in mechanical communication with the generator 120. The generator 120 is in electrical communication with the power network 130 such that mechanical energy from the engine 105 is converted by the generator 120 into electrical energy to be provided to the power network 130. The traction battery 110 is in electrical communication with the power network 130 and may be charged by the engine 105 via the power network 130. The regenerative braking system 125 is further in electrical communication with the power network 130. The power network 130 is configured to convert inertia from the vehicle 100 into electrical energy. The regenerative braking system 125 may charge the traction battery 110 via the power network 130 from the converted inertia. The motor 115 is in electrical communication with the power network 130. The motor 115 is configured to fulfill propulsion requests to the vehicle 100 using energy for the traction battery 110 via the power network 130.

The power network 130 includes a high voltage bus network 135, a low voltage bus network 140, and a converter 145. The high voltage bus network 135 is in electrical communication with the traction battery 110. The low voltage bus network 140 is used to fulfill electrical energy requests for vehicle loads 141. Such requests may include audio and climate control requests. The high voltage bus network 135 is in electrical communication with the low voltage bus network 140 via the converter 145.

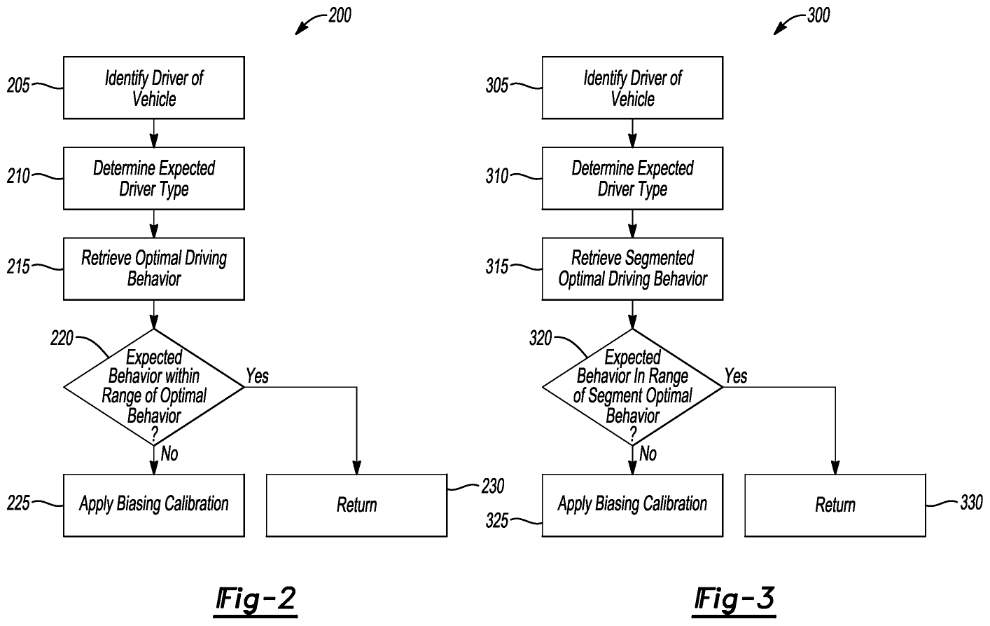

FIG. 2 illustrates a first calibration algorithm 200. The first calibration algorithm 200 begins with a identify driver step 205, in which the controller 160 identifies the driver. Next, the first calibration algorithm 200 moves to an expected driver type step 210, in which the controller 160 determines an expected driving behavior of the identified driver. Next the first calibration algorithm 200 moves to a retrieve optimal driving behavior step 215, in which the controller 160 retrieves the optimal driving behavior from an optimal driving behavior algorithm 400. The controller 160 then compares the expected driving behavior and the optimal driving behavior in the compare optimal to expected step 220. The controller 160 may then adjust the calibration if required in the apply calibration step 225. After the apply calibration step 225, or if the expected driving behavior substantially matches the optimal driving behavior, the first calibration algorithm 200 will move to a return 230 and await an additional calibration query.

FIG. 3 illustrates a second calibration algorithm 300. The second calibration algorithm 300 begins with a identify driver step 305, in which the controller 160 identifies the driver. Next, the second calibration algorithm 300 moves to an expected driver type step 310, in which the controller 160 determines an expected driving behavior of the identified driver. Next the second calibration algorithm 300 moves to a retrieve segmented optimal driving step 315, in which the controller 160 retrieves a segmented optimal driving behavior from an optimal driving behavior algorithm 400. A segmented optimal driving behavior may consider various calibrations that may need to be made along a route. The second calibration algorithm 300 then moves towards a produce protocol for battery step 320, in which the controller 160 will produce a protocol based on the expected driving behavior and the segmented optimal driving behavior. The controller 160 will then apply the protocol to a vehicle battery in the apply protocol for battery step 325. Finally, the second calibration algorithm 300 will move to an apply protocol for battery step 325 and await additional calibration queries.

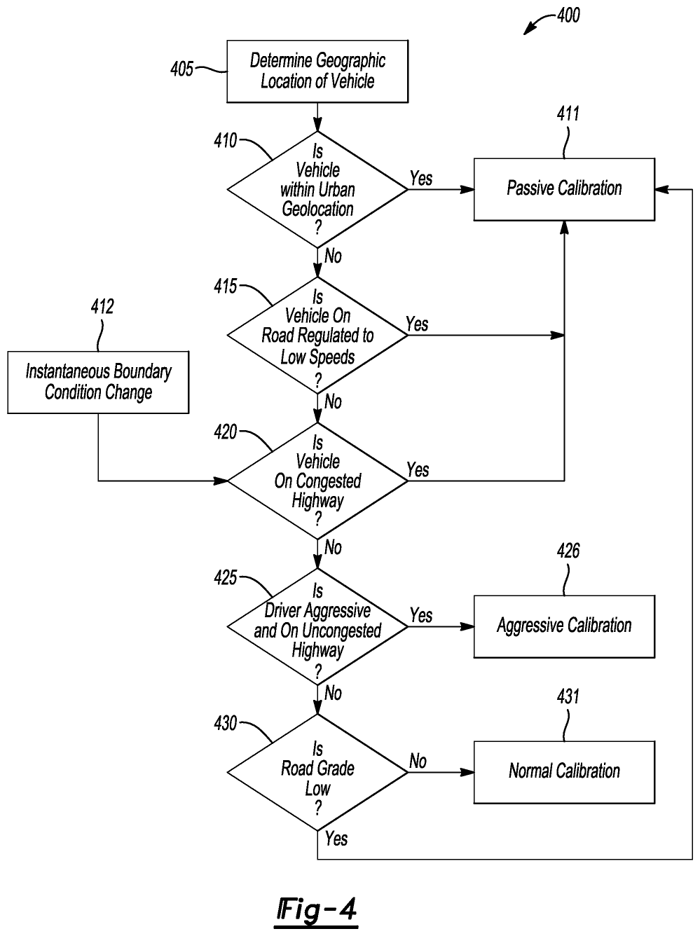

FIG. 4 illustrates an optimal driving behavior algorithm 400. The optimal driving behavior algorithm 400 begins by identifying the geographic location in an obtain geo location step 405. Next the optimal driving behavior algorithm 400 will determine if the vehicle is within an urban setting in an urban setting step 410. Next, the optimal driving behavior algorithm 400 will determine if the vehicle is in a low speed zone in a low speed regulation step 415. A low speed zone could be a speed zone of less than urban setting step 410. Next, the optimal driving behavior algorithm 400 will determine if it is located on a highway with low congestion in the highway congestion step 420. If either the obtain geo location step 405, urban setting step 410, low speed regulation step 415, or highway congestion step 420 are true, the optimal driving behavior algorithm 400 will return a signal indicative of a passive calibration 411. If the obtain geo location step 405, urban setting step 410, low speed regulation step 415, and highway congestion step 420 are false, and additionally a highway/aggressive driver step 425 is true, the optimal driving behavior algorithm 400 will return a signal indicative of an aggressive calibration 426. Lastly, if the obtain geo location step 405, urban setting step 410, low speed regulation step 415, highway congestion step 420, and highway/aggressive driver step 425 are true, in addition to a low road grade step 430 being true, the optimal driving behavior algorithm 400 will return a signal indicative of a default calibration 431.

In some examples, a controller commands a change in an amount of torque produced by a powertrain for a given change in pedal position according to a default calibration schedule that is defined by a driving style of a driver such that the change is different for different drivers. The default driving style for one driver may be passive, whereas the default driving style for another driver may be nominal or aggressive. A number of techniques for determining a driver's driving style are known and may be used. A passive driving style may indicate that a driver's pedal inputs are less drastic than for a nominal or aggressive driver. An aggressive driver, for example, may be more likely to repeatedly jam on the accelerator pedal or brakes than a passive driver for a same driving situation. Also, an aggressive driver may be more likely to change accelerator pedal or brake pedal positions for a given set of circumstances as compared with a nominal or passive driver. A passive driver may thus be given a passive default calibration schedule in which a change in the amount of torque produced for a given change in pedal input may be less than for a nominal calibration schedule. The same relation may hold true relative to an aggressive default calibration schedule. Put differently, with regard to default calibration schedules, the more aggressive the driver is with pedal inputs, the more responsive the drivetrain may be to such pedal inputs (e.g., small changes in pedal position may result in larger changes in torque outputs). The more passive the driver is with pedal inputs, the less responsive the drivetrain may be to such inputs (e.g., small changes in pedal position may result in smaller changes in torque outputs).

For as long as certain driving conditions are present however, the controller may command the change in the amount of torque according to an override calibration schedule and not the default calibration schedule provided that the change in the amount of torque according to the override calibration schedule is different than the change in the amount of torque according to the default calibration schedule. If for example the vehicle is on a highway and the default calibration style is passive or nominal, the controller may command changes in torque output according to an aggressive calibration schedule and not the default passive or nominal calibration schedule. That is, even though a driver's driving style may be passive or nominal, the powertrain will become more responsive to pedal inputs as long as the vehicle is on a highway. Once off the highway, the powertrain will become less responsive according to the passive or nominal driving style of the driver. If the vehicle is on a highway and the default calibration style is aggressive, the controller will continue to command changes in torque output according to the default calibration schedule because the override calibration schedule triggered by being on a highway is the same as the default calibration schedule. Standard global position technology, for example, can be used to determine such vehicle locations.

If for example the vehicle is in a city, in a subdivision, on a parking lot, on a driveway, or in an area with a low speed limit (e.g., 25 miles per hour) or traffic congestion and the default calibration schedule is nominal or aggressive as determined by the driver's driving style, the controller may command changes in torque output according to the passive calibration schedule and not the default nominal or aggressive calibration schedule. That is, even though the driver's driving style may be nominal or aggressive, the powertrain will become less responsive to pedal inputs as long as the vehicle is in a city, in a subdivision, on a parking lot, on a driveway, or in an area with a low speed limit. Once away from these locations, the powertrain will become more responsive according to the default nominal or aggressive calibration schedule. If the vehicle is in a city, in a subdivision, on a parking lot, on a driveway, or in an area with a low speed limit, and the default calibration style is passive, the controller will continue to command changes in torque output according to the passive default calibration schedule because the override calibration schedule triggered by being in these locations is the same as the default calibration schedule.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as Read Only Memory (ROM) devices and information alterably stored on writeable storage media such as floppy disks, magnetic tapes, Compact Discs (CDs), Random Access Memory (RAM) devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure.

As previously described, the features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A powertrain system comprising:
a powertrain; and
a controller programmed to
command a change in torque produced by the powertrain for a given change in pedal position according to a default calibration schedule that is defined by a driver such that the change in the torque is different for different drivers, and
for as long as a predefined set of driving conditions is present,
command the change in the torque according to an override calibration schedule and not the default calibration schedule provided that the change in the torque according to the override calibration schedule is different than the change in the torque according to the default calibration schedule, and
command the change in the torque according to the default calibration schedule otherwise.

2. The powertrain system of claim 1, wherein the change in the torque according to the override calibration schedule is greater than the change in the torque according to the default calibration schedule.

3. The powertrain system of claim 2, wherein the predefined conditions include a location being on a highway.

4. The powertrain system of claim 1, wherein the change in the torque according to the override calibration schedule is less than the change in the torque according to the default calibration schedule.

5. The powertrain system of claim 4, wherein the predefined conditions include a location being in a city, in a subdivision, on a parking lot, or on a driveway.

6. The powertrain system of claim 4, wherein the predefined conditions include a speed limit less than a predefined value.

7. The powertrain system of claim 4, wherein the predefined conditions include traffic congestion.

8. The powertrain system of claim 1, wherein the torque is propulsive torque.

9. A vehicle comprising:
a drivetrain;
a traction battery configured to provide electrical energy to the drivetrain; and
a controller programmed to,
operate the traction battery and drivetrain to propel the vehicle according to a first responsiveness of the drivetrain to pedal inputs based on identification of a first driver and a first set of environmental conditions, and
operate the traction battery and drivetrain to propel the vehicle according to a second responsiveness of the drivetrain to pedal inputs based on identification of the first driver and a second set of environmental conditions.

10. The vehicle of claim 9, wherein the controller is further programmed to operate the traction battery and drivetrain to propel the vehicle according to a third responsiveness of the drivetrain to pedal inputs based on identification of a second driver and the first set of environmental conditions.

11. The vehicle of claim 9, wherein the first set of environmental conditions includes weather conditions.

12. The vehicle of claim 9, wherein the first set of environmental conditions includes traffic conditions.

13. The vehicle of claim 9, wherein the first set of environmental conditions includes road conditions.

14. A method comprising:
while a vehicle is not on a highway, commanding a change in torque produced by a powertrain of the vehicle for a given change in pedal position according to a default calibration schedule that is defined by a driver such that the change in torque is different for different drivers, and
while the vehicle is on a highway, commanding the change in torque according to an override calibration schedule and not the default calibration schedule provided that the change in the torque according to the override calibration schedule is different than the change in the torque according to the default calibration schedule.

15. The method of claim 14, wherein the change in the torque according to the override calibration schedule is greater than the change in the torque according to the default calibration schedule.

16. The method of claim 14 further comprising while the vehicle is in a city or subdivision and not on a highway, commanding the change in the torque according to another override calibration schedule and not the default calibration schedule provided that the change in the torque according to the another override calibration schedule is different than the change in the torque according to the default calibration schedule.

17. The method of claim 16, wherein the change in the torque according to the override calibration schedule is less than the change in the torque according to the default calibration schedule.

18. The method of claim 14 further comprising while the vehicle is on a parking lot or driveway and not on a highway, commanding the change in the torque according to another override calibration schedule and not the default calibration schedule provided that the change in the torque according to the another override calibration schedule is different than the change in the torque according to the default calibration schedule.

19. The method of claim 18, wherein the change in the torque according to the override calibration schedule is less than the change in the torque according to the default calibration schedule.
